(19) United States
(12) Patent Application Publication
(10) Pub. No.: US 2025/0044597 A1
(43) Pub. Date: Feb. 6, 2025

(54) VIRTUAL-IMAGE DISPLAY DEVICE

(71) Applicant: SEIKO EPSON CORPORATION, Tokyo (JP)

(72) Inventors: Toshiaki MIYAO, CHINO-SHI (JP); Toshiyuki NOGUCHI, SHIOJIRI-SHI (JP); Takuya IKEDA, SHIOJIRI-SHI (JP)

(73) Assignee: SEIKO EPSON CORPORATION, Tokyo (JP)

(21) Appl. No.: 18/788,099

(22) Filed: Jul. 29, 2024

(30) Foreign Application Priority Data
Jul. 31, 2023 (JP) 2023-124199

(51) Int. Cl. G02B 27/01

(52) U.S. Cl. CPC G02B 27/0172

(57) ABSTRACT

A virtual-image display device includes: a first display unit including a first image element, a first projection optical system, and a first mirror; a second display unit including a second image element, a second projection optical system, and a second mirror; a coupling member configured to couple the first display unit and the second display unit; a penetration-type fitting structure formed at an attaching section and at a support portion, the attaching section being formed at the first display unit, the support portion being provided at the coupling member; and a photocurable-type adhesive material held between the attaching section and the support portion, in which an additional light transmitting structure is formed at one of the attaching section and the support portion, and the light transmitting structure is configured to cause light to reach a boundary region between the attaching section and the support portion.

The present application is based on, and claims priority from JP Application Serial Number 2023-124199, filed on Jul. 31, 2023, the disclosure of which is hereby incorporated by reference herein in its entirety.

### BACKGROUND

### 1. Technical Field

The present disclosure relates to a head-mounted type virtual-image display device that enables a virtual image to be observed.

### 2. Related Art

A virtual-image display device is known (JP-A-2012-18414). The virtual-image display device includes: two image display devices arranged in the lateral direction; a coupling member that couples upper portions of center-side end portions of two light guiding units provided at these image display devices; and an eyeglass-type frame mounted on the head of an observer. This virtual-image display device has a structure in which the coupling member is attached and is supported at the center of the frame in a suspending manner.

In the device described in the Related Art, a screw or adhesive is used in the method of fixing the coupling member and the light guiding unit. However, from the viewpoint of variations in manufacturing, it is possible to increase the degree of freedom of adjustment by using adhesive to fix them, rather than by using a screw to fix them. Of the adhesive, a photocurable-type adhesive is preferable from the viewpoint of reducing the number of processes or the like.

However, when the coupling member and the light guiding unit are fixed using the photocurable-type adhesive, the adhesive is left in a half-cured state or uncured state if the coupling member is made of metal and a shadow is made for the curing light, for example. This makes it uneasy to secure the strength of bonding.

### SUMMARY

A virtual-image display device according to an aspect of the present disclosure includes a first display unit including a first image element, a first projection optical system configured to project image light from the first image element, and a first mirror configured to reflect the image light from the first projection optical system, a coupling member configured to couple the first display unit and a second display unit, a penetration-type fitting structure formed at an attaching section and at a support portion, the attaching section being formed at the first display unit, the support portion being provided at the coupling member, and a photocurable-type adhesive material put in between the attaching section and the support portion, in which a light transmitting structure is formed, at one of the attaching section and the support portion, between the attaching section and the support portion, and at or around the fitting structure.

### BRIEF DESCRIPTION OF THE DRAWINGS

FIG. 1 is a perspective view illustrating an external appearance used to explain a state in which a head-mounted display apparatus is worn.

FIG. 2 is a side cross-sectional view used to explain an optical system or the like included in one side of a virtual-image display device.

FIG. 3 is a perspective view used to explain a display unit and a supporting structure for this.

FIG. 4 is a plan view of a support device and a cross-sectional view of the support device as viewed from the front.

FIG. 5 is an enlarged cross-sectional view illustrating an attaching section of a first frame member and a support portion of a coupling member.

FIG. 6 is a plan view used to explain a support device according to a modification example.

FIG. 7 is a plan view used to explain a support device according to another modification example.

FIG. 8 is a partially enlarged cross-sectional view used to explain yet another modification example.

FIG. 9 is a perspective view used to explain the external shape of a display section.

FIG. 10 is a side cross-sectional view illustrating a barrel and an optical member held by this.

FIG. 11 is a partially enlarged cross-sectional view used to explain a support device according to a second embodiment.

FIG. 12 is a plan view used to explain a support device according to a third embodiment.

FIG. 13 is a front view used to explain a support device according to a modification example.

### DESCRIPTION OF EMBODIMENTS

### First Embodiment

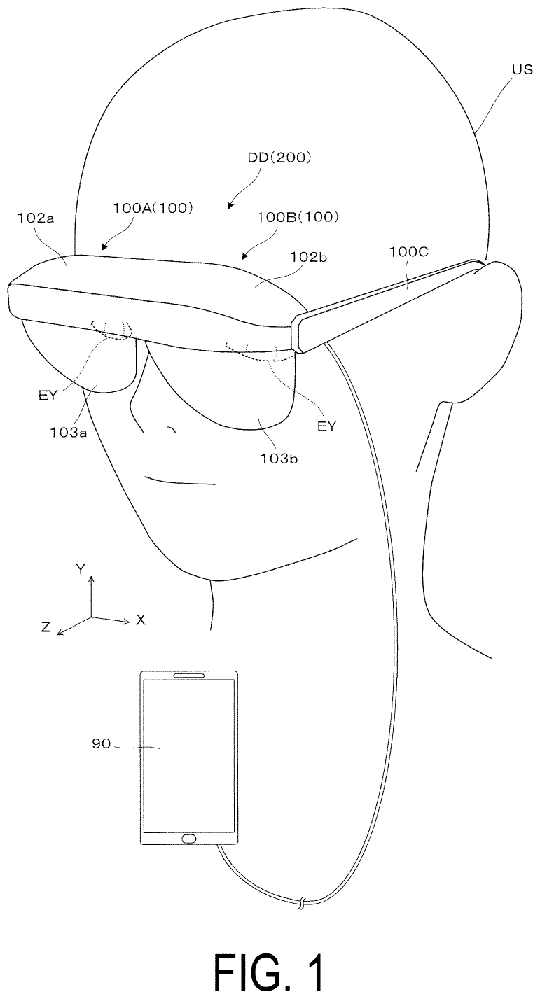

Below, a first embodiment of a virtual-image display device according to the present disclosure will be described with reference to FIGS. 1 to 3 or the like.

FIG. 1 is a diagram illustrating a state in which a head-mounted display apparatus (hereinbelow, also referred to as a head-mounted display or HMD) 200 serving as a virtual-image display device DD according to the first embodiment is worn. The virtual-image display device DD, that is, the HMD 200 allows an observer or a wearer US who wears this device to recognize an image serving as a virtual image. In FIG. 1 or the like, X, Y, and Z represent a rectangular coordinate system. The +X direction corresponds to a lateral direction in which both eyes EY of the observer or the wearer US who wears the HMD 200 are arranged. The +Y direction corresponds to the upper direction perpendicular to the lateral direction from the viewpoint of the wearer US in which both eyes EY are arranged. The +Z direction corresponds to the forward direction or the front side direction from the viewpoint of the wearer US. The ±Y direction is parallel to the vertical axis or the vertical direction.

The virtual-image display device DD includes a first virtual-image display unit 100A for a right eye, a second virtual-image display unit 100B for a left eye, a pair of mounting devices 100C having a temple shape and configured to support the virtual-image display units 100A and 100B, and a user terminal 90 serving as an information terminal. The first virtual-image display unit 100A alone functions as the HMD, and includes a first display driving unit 102a disposed at an upper portion, and a first combiner 103a having a shape of a spectacle lens and covering the front of an eye. Similarly, the second virtual-image display unit 100B alone functions as the HMD, and includes a second display driving unit 102b disposed at the upper portion, and a second combiner 103b having a shape of a spectacle lens and covering the front of an eye. The mounting devices 100C are configured to be worn on the head of the wearer US, and support upper end sides of the pair of combiners 103a and 103b via the display driving units 102a and 102b that are integrated in the external appearance. The first virtual-image display unit 100A and the second virtual-image display unit 100B are optically identical or left-right inverted, and detailed description of the second virtual-image display unit 100B will not be made.

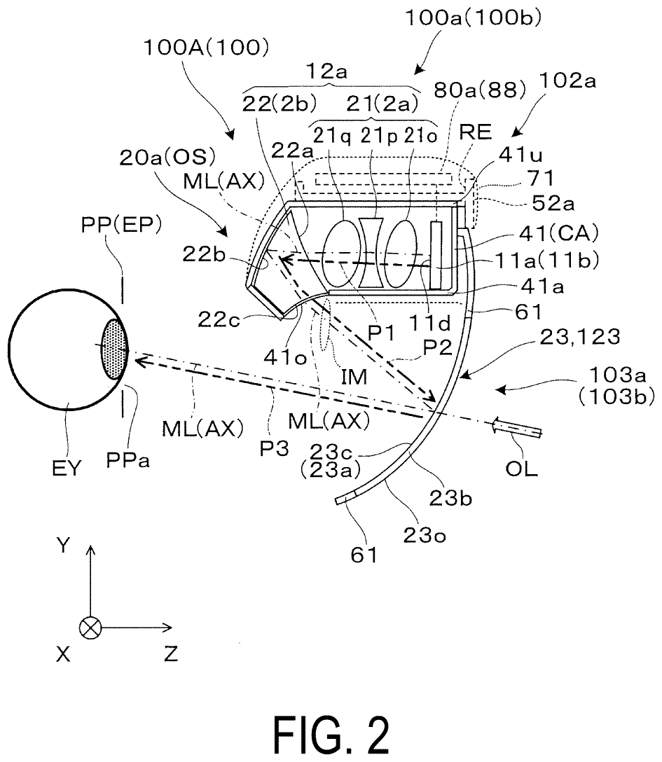

FIG. 2 is a side cross-sectional view illustrating the internal structure of the first virtual-image display unit 100A. The first virtual-image display unit 100A includes a first image element 11a, a first display section 20a, and a first circuit member 80a. The first display section 20a is an image-formation optical system configured to form a virtual image, and includes a projection lens 21, a prism mirror 22, and a see-through mirror 23. Of the first display section 20a, the projection lens 21 and the prism mirror 22 function as a first projection optical system 12a where image light ML from the first image element 11a enters. The first display section 20a includes the first projection optical system 12a and the see-through mirror 23 in an integrated state. The projection lens 21 that constitutes the first projection optical system 12a corresponds to a first optical member 2a disposed at the light output side of the first image element 11a. The prism mirror 22 corresponds to a second optical member 2b disposed at the light output side of the first optical member 2a that is the projection lens 21. In addition, the first image element 11a, the projection lens 21, and the prism mirror 22 correspond to a portion of the first display driving unit 102a illustrated in FIG. 1, and the see-through mirror 23 corresponds to the first combiner 103a illustrated in FIG. 1. The projection lens 21 and the prism mirror 22 that constitute the first projection optical system 12a are fixed in a container-shaped barrel 41 in a state in which they, together with the first image element 11a, are positioned relative to each other. The barrel 41 is a case CA that accommodates the first projection optical system 12a and the first image element 11a in a state where they are positioned.

In the first virtual-image display unit 100A, the first image element 11a is a self-emission type image-light generation device. The first image element 11a emits image light ML to the first projection optical system 12a. The first image element 11a is accommodated in the barrel 41 from the rear side, and is supported. For example, the first image element 11a is an organic EL (organic electro-luminescence) display, and forms a color still image or video on a two-dimensional display surface 11d. The first image element 11a is driven by a display control device 88 including the first circuit member 80a to perform display operation. The first image element 11a is not limited to the organic EL display, and it is possible to replace the first image element 11a with a display device such as an inorganic EL, organic LED, LED array, laser array, a quantum-do self-emission type element, or the like. The first image element 11a is not limited to the self-emission type image-light generation device, and it may be possible to employ a device configured to include an LCD or other optical modulation elements and illuminating the optical modulation element with a light source such as a back light to form an image. As for the first image element 11a, it may be possible to use an LCOS (Liquid crystal on silicon, LCoS is a registered trademark), a digital micro-mirror device, or the like, in place of the LCD. Note that, in the first virtual-image display unit 100A, an optical device excluding the first circuit member 80a or the display control device 88 is referred to as an optical unit 100.

The first display section 20a includes two reflective surfaces, and the optical path therein is bend with the see-through mirror 23 and the prism mirror 22. The first display section 20a is an off-axis optical system OS. That is, the projection lens 21, the prism mirror 22, and the see-through mirror 23 are disposed to be non-axisymmetric. In correspondence with being non-axisymmetric, the optical surfaces of optical elements that constitute the first display section 20a each basically have asymmetry across the optical axis AX and relative to the longitudinal direction running parallel to the YZ plane and intersecting the optical axis AX with the optical axis AX being interposed, and have symmetry cross the optical axis AX and relative to the lateral direction or the X direction. In this first display section 20a, the optical axis AX is bent in an off-axis surface parallel to the YZ plane serving as the reference surface, whereby the optical elements 21, 22 and 23 are arrayed along the off-axis surface (that is, the reference surface). Specifically, in the off-axis surface parallel to the YZ plane and corresponding to a plane of paper, an optical path portion Ph from the projection lens 21 to a reflective surface 22b, an optical path portion P2 from the reflective surface 22b to the see-through mirror 23, and an optical path portion P3 from the see-through mirror 23 to the pupil position PP are arranged so as to be bent in a letter-Z shape in two stages.

In the first display section 20a, the optical path portion P1 from the projection lens 21 to the reflective surface 22b extends in a slightly obliquely upward direction or a direction nearly parallel to the Z direction toward a rearward direction with respect to a viewpoint. The optical path portion P2 from the reflective surface 22b to the see-through mirror 23 extends obliquely downward toward a frontward side. When the horizontal plane direction (XZ plane) is used as a reference, an inclination of the optical path portion P2 is greater than the inclination of the optical path portion P1. The optical path portion P3 from the see-through mirror 23 to the pupil position PP extends slightly obliquely upward or in a direction nearly parallel to the Z direction toward the −Z direction that is the rearward direction. In the example illustrated in the drawing, a portion of the optical axis AX that corresponds to the optical path portion P3 corresponds to approximately −10°, with the downward direction toward the +Z direction being set as negative.

In the first display section 20a, the projection lens 21 includes a first lens 21o, a second lens 21p, and a third lens 21q. The projection lens 21 receives the image light ML outputted from the first image element 11a to cause the light to enter the prism mirror 22. The projection lens 21 collects the image light ML outputted from the first image element 11a to make it into a state close to a collimated light beam.

The prism mirror 22 is an optical member having a refractive reflection function that is a mixture of a mirror function and a lens function, and reflects the image light ML from the projection lens 21 while refracting it. The prism mirror 22 includes: an incident surface 22a disposed on the light output side of the first optical member 2a; the reflective surface 22b for bending the optical axis AX; and a light exit surface 22c opposed to the reflective surface 22b and disposed in a direction symmetrical to the incident surface 22a. The prism mirror 22 emits the image light ML entering from the front side at which the projection lens 21 is disposed, such that the image light ML is bent in a direction inclined downward with respect to a direction (a direction of a light source as seen from the prism mirror 22) reverse to the incident direction. The reflective surface 22b is not limited to one that reflects the image light ML by total reflection, and it is possible to employ a reflective surface comprised of a metal film or a dielectric multilayer film.

The see-through mirror 23, that is, the first combiner 103a is a curved plate-shaped optical external member 123 that functions as a concave surface mirror, and partially reflects the image light ML from the prism mirror 22 while partially transmitting external light OL. The see-through mirror 23 includes a partial reflective surface 23c and an outside surface 23o. The see-through mirror 23 covers the pupil position PP at which the eye EY or the pupil is disposed, and has a concave shape toward the pupil position PP, thereby having a convex shape toward the outside. The pupil position PP or an opening PPa thereof is referred to as an eye point or an eye box, and corresponds to an emission pupil EP of the first display section 20a including the see-through mirror 23. The see-through mirror 23 serves as the concave mirror having positive power, and makes it possible to enlarge the view of the intermediate image IM formed by the first image element 11a and re-imaged by the first projection optical system 12a.

The partial reflective surface 23c of the see-through mirror 23 transmits a portion of light when reflecting the image light ML. This allows the external light OL to pass through the see-through mirror 23 to achieve see-through view of the outside, which makes it possible to superimpose a virtual image on an outside-world image. At this time, when the base member 23b has a thickness of less than or equal to approximately a few millimeters, it is possible to reduce a change in multiplication factor of the outside-world image. A reflectance of the partial reflective surface 23c with respect to the image light ML and the external light OL is set to not less than 10% and not more than 50% in a range of an incident angle of the assumed image light ML from the viewpoint of ensuring a brightness of the image light ML and facilitating observation of the outside-world image by see-through. The base member 23b of the see-through mirror 23 is made, for example, of resin, and can be made of glass. The base member 23b is made of the same material as a support plate 61 that supports the base member 23b from the surrounding thereof, and has the same thickness as the support plate 61. A transmissive reflective film 23a is made, for example, of a dielectric multilayer film including a plurality of dielectric layers having an adjusted film thickness. The transmissive reflective film 23a may be a single-layer film or a multilayer film of metal such as Al or Ag of which film thickness has been adjusted.

The optical path will be described. The image light ML from the first image element 11a enters the projection lens 21 and is outputted from the projection lens 21 in a substantially collimated state. The image light ML that has passed through the projection lens 21 enters the prism mirror 22 to pass through the incident surface 22a while being refracted. Then, the light is reflected by the reflective surface 22b with a high reflectance close to 100%, and is refracted again by the light exit surface 22c. The image light ML from the prism mirror 22 once forms the intermediate image IM, and then enters the see-through mirror 23, and is reflected by the partial reflective surface 23c with a reflectance of not more than approximately 50%. The image light ML reflected by the see-through mirror 23 enters the pupil position PP at which the eye EY or pupil of the wearer US is disposed. The external light OL that has passed through the see-through mirror 23 and the support plate 61 therearound also enters the pupil position PP. In other words, the wearer US who wears the first virtual-image display unit 100A can observe a virtual image made of the image light ML in a state where it is superimposed on an outside-world image.

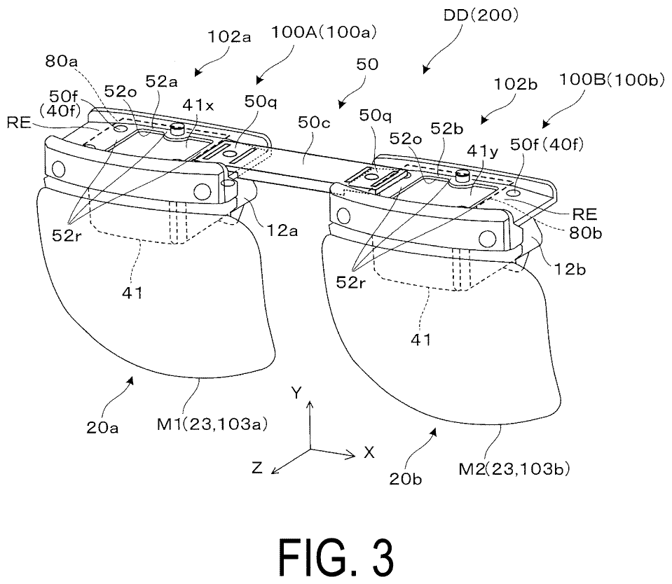

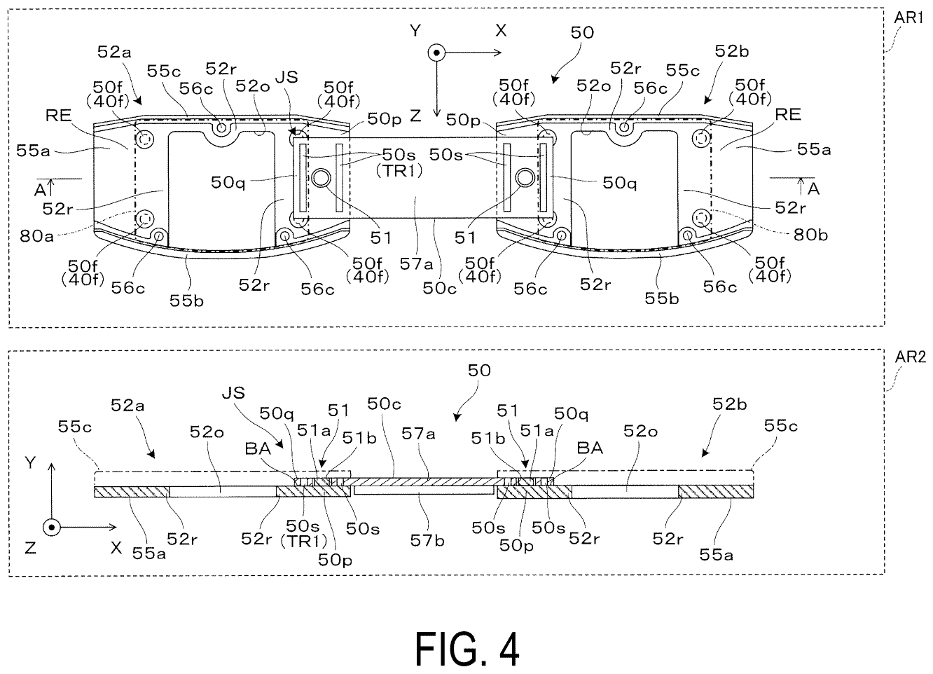

Description will be made of a supporting structure incorporated in the display driving units 102a and 102b of the virtual-image display device DD with reference to FIGS. 3 and 4. FIG. 3 is a perspective view illustrating the supporting structure of a display section. FIG. 4 is a diagram illustrating a support device 50 in detail. In FIG. 4, a region AR1 is a plan view of the support device 50, and a region AR2 is a cross-sectional view taken along the arrowed AA in the support device 50 illustrated in the region AR1.

In the first virtual-image display unit 100A, a first frame member 52a that constitutes the support device 50 is fixed to an upper portion 41x of the first display section 20a by using a fastening member 50f such as a screw or the like, and supports the first display section 20a or the barrel 41 in a suspending manner. Note that, as for the method of fixing the first frame member 52a, it may be possible to employ various manners including fixing using caulking, fixing using an adhesive, fixing using fitting-into, or adhesive fixing, in addition to screw fixing. The first frame member 52a constitutes a portion of a first display unit 100a corresponding to the first virtual-image display unit 100A. Here, as illustrated in FIG. 2, the first display unit 100a includes the first image element 11a, the first projection optical system 12a configured to project an image formed by the first image element 11a, and the first combiner 103a serving as a first mirror M1 configured to reflect the image light ML outputted from the first projection optical system 12a.

With reference mainly to FIG. 4, the first frame member 52a includes: a flat plate portion 55a including an opening 52o and having substantially a rectangular shape as a whole; and a pair of reinforcement protrusions 55b and 55c that protrude upward from the flat plate portion 55a. The first reinforcement protrusion 55b protrudes to an upper side that is the +Y side and a lower side that is the −Y side, and extends in the lateral X direction as a whole while being slightly curved. In addition, the second reinforcement protrusion 55c protrudes only to the upper side that is the +Y side, and extends in the lateral X direction as a whole while being slightly curved. The pair of reinforcement protrusions 55b and 55c are provided to enhance the structural strength of the first frame member 52a, and increases the strength of the flat plate portion 55a that is relatively weak against bending and torsion.

In the first frame member 52a, a space disposed above the flat plate portion 55a and interposed between the pair of reinforcement protrusions 55b and 55c is a recess portion RE and can accommodate the first circuit member 80a. Note that the height of an upper end of the first circuit member 80a may be higher than each of the heights of the upper ends of the pair of reinforcement protrusions 55b and 55c. In the first frame member 52a, screw holes 56c formed at three locations in the periphery of the opening 52o are used to fix the first circuit member 80a to the first frame member 52a.

A portion (specifically, three sides except for the +Z side) of a periphery 52r of the rectangle opening 52o formed in the first frame member 52a comes into close contact with the upper portion 41x of the barrel 41 of the first display section 20a illustrated in FIG. 3. At this time, the lower surface of the first frame member 52a and the upper portion 41x of the barrel 41 are fitted together to achieve positioning of the first frame member 52a and the first display section 20a, that is, the barrel 41. The first frame member 52a is made, for example, of a metal material such as magnesium alloy or the like. By forming the first frame member 52a using a magnesium alloy, it is possible to enhance an effect of cooling the first frame member 52a, the first display section 20a, and the like through thermal radiation.

Returning to FIG. 3, in the second virtual-image display unit 100B, a second frame member 52b that constitutes the support device 50 is fixed to an upper portion 41y of the barrel 41 of the second display section 20b by using the fastening member 50f such as a screw or the like, and supports the second display section 20b or the barrel 41 in a suspending manner. The second frame member 52b constitutes a portion of a second display unit 100b corresponding to the second virtual-image display unit 100B. Here, the second display unit 100b includes the second image element 11b, a second projection optical system 12b configured to project an image formed by the second image element 11b, and the second combiner 103b serving as a second mirror M2 configured to reflect the image light ML outputted from the second projection optical system 12b (see FIG. 2).

With reference mainly to FIG. 4, the second frame member 52b also includes: a flat plate portion 55a having substantially a rectangular shape as a whole; and a pair of reinforcement protrusions 55b and 55c that protrude upward from the flat plate portion 55a. The first reinforcement protrusion 55b protrudes upward and downward, and extends in the lateral X direction as a whole while being slightly curved. The second reinforcement protrusion 55c protrudes only to the upper side, and extends in the lateral X direction as a whole while being slightly curved.

In the second frame member 52b, a space disposed above the flat plate portion 55a and interposed between the pair of pair of reinforcement protrusions 55b and 55c is the recessed portion RE where a second circuit member 80b can be accommodated. In the second frame member 52b, screw holes 56c formed at three locations in the periphery of the opening 52o are used to fix the second circuit member 80b to the second frame member 52b.

A portion (specifically, three sides except for the +Z side) of a periphery 52r of the rectangle opening 52o formed in the second frame member 52b comes into close contact with the upper portion 41y of the barrel 41 of the second display section 20b illustrated in FIG. 3. At this time, the lower surface of the second frame member 52b and the upper portion 41y of the barrel 41 are fitted together to achieve positioning of the second frame member 52b and the second display section 20b, that is, the barrel 41. By forming the second frame member 52b using a metal material such as a magnesium alloy, it is possible to enhance an effect of cooling the second frame member 52b and the second display section 20b through thermal radiation.

Although illustration is not given, the left-side end or −X end of the first frame member 52a and the right-side end or +X end of the second frame member 52b are joined to the mounting devices 100C illustrated in FIG. 1 through a coupling member such as a hinge, and are supported by the mounting devices 100C.

In addition to the first frame member 52a and the second frame member 52b, the support device 50 includes a coupling member 50c configured to join the first frame member 52a and the second frame member 52b together to relatively fix them. The coupling member 50c includes a flat plate portion 57a having a rectangular shape, and a pair of reinforcement protrusions 57b that protrude downward from the flat plate portion 57a. The coupling member 50c is a member made of metal such as magnesium alloy, and includes a support portion 50q at one end and a support portion 50q at the other end. The support portion 50q at one end is joined to an attaching section 50p serving as one end portion of the first frame member 52a. The support portion 50q at the other end is joined to an attaching section 50p serving as one end portion of the second frame member 52b. The first frame member 52a to which the first display section 20a is attached and the second frame member 52b to which the second display section 20b is attached are fixed in a mutually and optically positioned state via the coupling member 50c at the center. Joining these frame members 52a and 52b via the coupling member 50c makes it easy to adjust the arrangement relationship of these frame members 52a and 52b.

When the support device 50 is made of metal and the first frame member 52a, the second frame member 52b, and the coupling member 50c are made of metal, it is possible to increase the accuracy of the structure of each of the members 52a, 52b, and 50c while enhancing the strength thereof and reducing the weight thereof. However, when the coupling member 50c and the frame members 52a and 52b are made of metal, it is not possible to make these members have optical transparency. Thus, an additional light transmitting structure TR1 that will be described later is provided to achieve sufficient curing of a photocurable-type adhesive.

At the attaching section 50p formed in the first frame member 52a and the first display unit 100a and the support portion 50q provided in the coupling member 50c, a penetration-type fitting structure 51 is formed as a portion of the attaching section 50p and the support portion 50q. A combination of the attaching section 50p and the support portion 50q is referred to as a joint section JS.

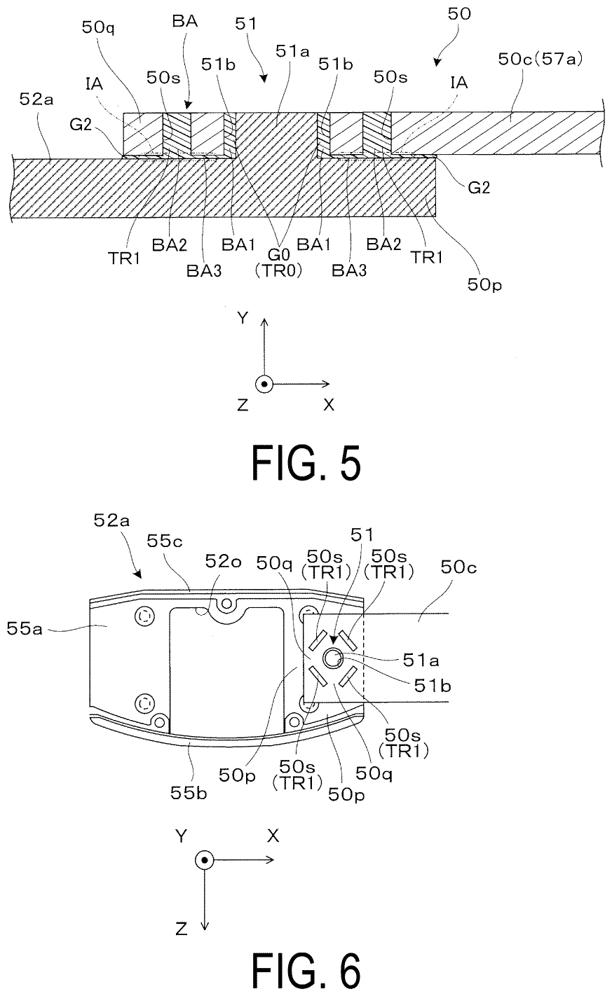

As illustrated in FIG. 5, the fitting structure 51 includes a pin-shaped protrusion 51a, and a through hole 51b having a tubular inner surface to be fitted with the protrusion 51a. The protrusion 51a is formed at the attaching section 50p. The through hole 51b is formed in the support portion 50q. By combining the protrusion 51a and the through hole 51b together, it is possible to easily attach the first display unit 100a (see FIG. 3) to the coupling member 50c, and it is possible to easily adjust mutual positions of the first display unit 100a and the second display unit 100b. A tubular space G0 formed between the protrusion 51a and the through hole 51b and serving as adjustment play functions as a light transmitting structure TR0.

The support portion 50q of the coupling member 50c includes two slit-shaped holes 50s formed in the vicinity of the fitting structure 51. Two holes 50s are provided with the fitting structure 51 being interposed between them, and extend in the front-rear Z direction so as to cross the coupling member 50c. The holes 50s are each formed as an elongated hole that is shorter than the width, in the front-rear Z direction, of the support portion 50q and penetrates through the support portion 50q. These elongated holes 50s are configured to expose a wide area of a boundary region G2 between the attaching section 50p and the support portion 50q, and function as the additional light transmitting structure TR1 configured to allow curing light to reach the boundary region G2. The slit-shaped holes 50s can be machined relatively easily. Thus, it is possible to easily maintain the strength of the support portion 50q. The light transmitting structure TR1 is provided so as to penetrate through the support portion 50q, which is one of the attaching section 50p and the support portion 50q, thereby causing the other one of the attaching section 50p to be exposed. In particular, the slit-shaped holes 50s expose an inner-side region IA of the boundary region G2 between the attaching section 50p and the support portion 50q. By exposing the inner-side region IA through the slit-shaped holes 50s in this manner, it is possible to easily cause the curing light to reach the internal region IA and its surroundings, which makes it possible to efficiently cure the boundary region G2 over the relatively wide area. In addition, by providing a plurality of slit-shaped holes 50s, it is possible to easily cause the curing light to reach a plurality of locations of the boundary region G2 between the attaching section 50p and the support portion 50a, which makes it possible to cure the boundary region G2 over the relatively wide area. In particular, when a plurality of slit-shaped holes 50s are provided with the fitting structure 51 being interposed between them, it is possible to achieve well-balanced fixing at or around the fitting structure 51 in a symmetric manner.

In the fitting structure 51, the outer diameter of the protrusion 51a is smaller than the inner diameter of the through hole 51b, and a first portion BA1 of a photocurable-type adhesive material BA is put into the space G0 between these items to be cured. In addition, a second portion BA2 of the photocurable-type adhesive material BA is put in and is cured in the two holes 50s provided so as to sandwich the fitting structure 51, that is, in a space formed in the additional light transmitting structure TR1. Furthermore, a third portion BA3 of the photocurable-type adhesive material BA is put in and is cured in the boundary region G2 formed between the upper surface of the attaching section 50p and the upper surface of the support portion 50q. Joining between the attaching section 50p and the support portion 50q, that is, joining between the first frame member 52a and the coupling member 50c is achieved mainly by the third portion BA3 and the first portion BA1.

Description will be made of fixing of the first frame member 52a to the coupling member 50c. By positionally adjusting the first frame member 52a relative to the coupling member 50c, the first frame member 52a is positioned relative to the coupling member 50c. At this time, when the barrel 41 or the like is fixed relative to the first frame member 52a, it is possible to position the first frame member 52a while optically measuring the first display section 20a or the like. Before or after the operation of positioning the first frame member 52a, the adhesive material BA before photocuring is supplied to the boundary region G2 between the attaching section 50p and the support portion 50q, is supplied to the space G0 between the protrusion 51a and the through hole 51b, and is supplied to the holes 50s. After this, curing light that is UV light having a wavelength, for example, of 340 nm is emitted to the adhesive material BA. Specifically, the UV light is emitted from the upper side of the through hole 51b or the upper side of the holes 50s. With this operation, the first portion BA1 corresponding to the space G0 is cured, the second portion BA2 corresponding to the holes 50s is cured, and the third portion BA3 is cured due to UV light propagated from these portions or chain-reaction effect of curing. In other words, the adhesive material BA as a whole is cured to fix the first frame member 52a to the coupling member 50c in a state where the positioning state of the first frame member 52a relative to the coupling member 50c is maintained. Note that traveling around of light or the like is used for the third portion BA3. Thus, there is a possibility that the third portion BA3 is incompletely cured due to the shadow of the support portion 50q. However, the slit-shaped hole 50s enables the area ratio of this to be reduced.

The structure used to fix the second frame member 52b, that is, the second display unit 100b to the coupling member 50c is the same as the structure used to fix the first display unit 100a to the coupling member 50c. That is, the structure used to fix the second frame member 52b to the coupling member 50c includes the penetration-type fitting structure 51, the photocurable-type adhesive material BA, and the additional light transmitting structure TR1. The method of fixing the second frame member 52b to the coupling member 50c is similar to the method of fixing the first frame member 52a to the coupling member 50c, and hence, explanation thereof will not be provided.

In the fitting structure 51, the space G0 between the protrusion 51a and the through hole 51b falls, for example, in a range of approximately 0.05 mm to 0.1 mm. However, it may be possible to set the space to be equal to or more than this range (for example, approximately 0.7 mm). The diameter of the through hole 51b is set to approximately 2.5 mm. However, it may be possible set it to be equal to or more than this size. The depth or the length of the through hole 51b corresponds to the thickness of the support portion 50q or the flat plate portion 57a, and is, for example, approximately 3 mm. However, the depth or the length thereof is not limited to this.

FIG. 6 is a partially enlarged plan view used to explain a modification example of the slit-shaped hole 50s. In this case, the slit-shaped hole 50s that functions as the additional light transmitting structure TR1 extends in an oblique direction that is an intermediate direction between the Z direction and the X direction, rather than extending in the front-rear Z direction. Note that, although illustration is not provided, the slit-shaped hole 50s may extend in the lateral X direction.

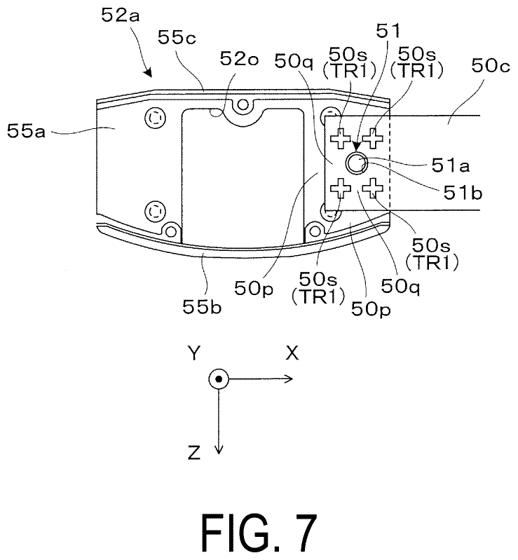

FIG. 7 is a partially enlarged plan view used to explain another modification example of the slit-shaped hole 50s. In this case, a slit-shaped hole 50s having a shape of a cross is provided in the support portion 50q of the coupling member 50c. The slit-shaped hole 50s having a shape of a cross also functions as the additional light transmitting structure TR1.

In the description above, the support portion 50q provided at the coupling member 50c is disposed at the upper side of the attaching section 50p provided at the first frame member 52a. However, the support portion 50q of the coupling member 50c may be disposed at the lower side of the attaching section 50p of the first frame member 52a. In this case, the fitting structure 51 and the like illustrated in FIG. 5 are disposed upside down. Specifically, for example, although illustration is not provided, the protrusion 51a is formed so as to extend downwardly from the attaching section 50p. The through hole 51b is formed at a location corresponding to the protrusion 51a at the support portion 50q. The two holes 50s are formed at the support portion 50q such that the through hole 51b is interposed between them.

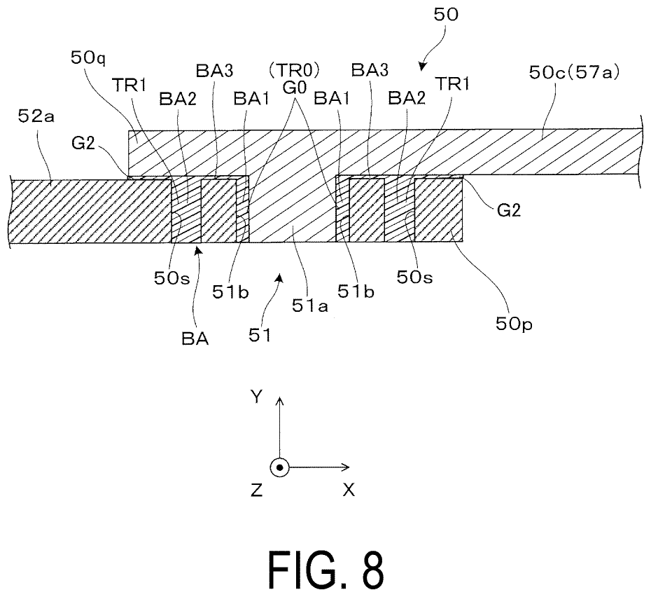

FIG. 8 illustrates an example in which the fitting structure 51 and the like illustrated in FIG. 5 is modified. In this case, the protrusion 51a is formed at the support portion 50q, and the through hole 51b is formed at the attaching section 50p. The two holes 50s are formed in the attaching section 50p and in the vicinity of the fitting structure 51 so as to correspond to swapping of arrangement as described above. The UV curing light is emitted from the −Y direction that is the lower side.

The first frame member 52a and the second frame member 52b are not limited to those made of metal, and may be members made of resin that does not have optical transparency or may be members made of resin having optical transparency. On the other hand, the coupling member 50c may be made of resin that does not have optical transparency, or may be made of resin having optical transparency. For example, when the frame members 52a and 52b are made of resin having optical transparency and the coupling member 50c is made of metal, the coupling member 50c is provided with the additional light transmitting structure TR1 to secure a situation where curing light is more likely to reach the adhesive material BA.

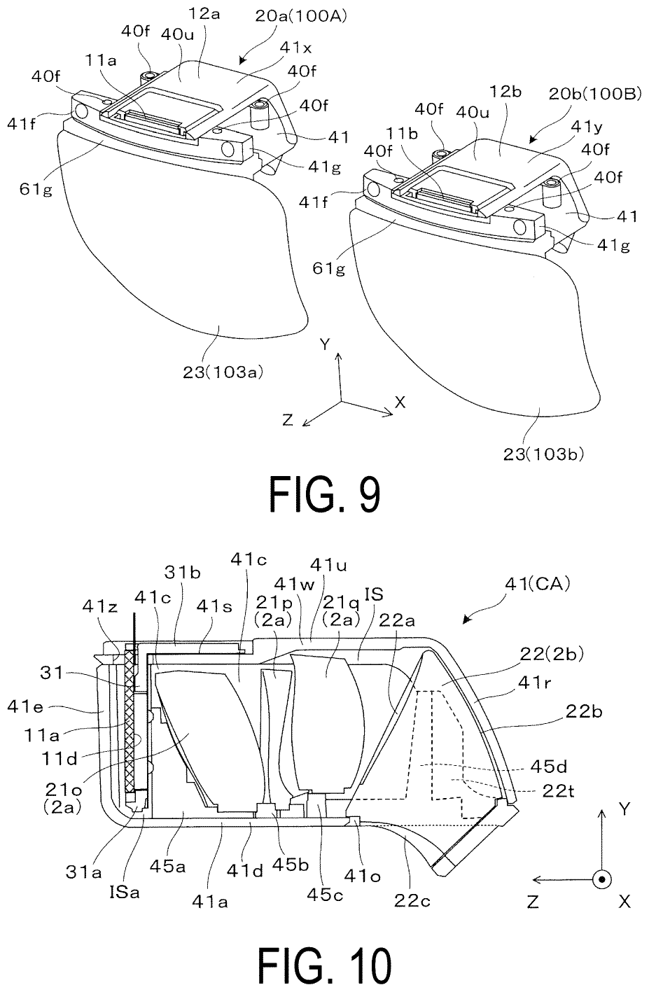

FIG. 9 is a perspective view illustrating a state in which no support device 50 is provided in the virtual-image display device DD illustrated in FIG. 3. The first display section 20a includes the first projection optical system 12a and the first combiner 103a in an integrated state. The second display section 20b includes the second projection optical system 12b and the second combiner 103b in an integrated state.

In the first projection optical system 12a, the first combiner 103a is fixed to the barrel 41 with adhesion or the like in an aligned state. At this time, an upper end 61g of the first combiner 103a is fixed to a pair of protrusion portions 41f and 41g that protrude from the front upper end of the barrel 41 at left and right outer sides. The barrel 41 of the first projection optical system 12a has a space used to accommodate the first image element 11a, and supports the first image element 11a in a state of being aligned with the projection lens 21 and the like illustrated in FIG. 2.

In the second projection optical system 12b, the second combiner 103b is fixed to the barrel 41 with adhesion or the like in an aligned state. At this time, an upper end 61g of the second combiner 103b is fixed to a pair of protrusion portions 41f and 41g that protrude from the front upper end of the barrel 41 at left and right outer sides. The barrel 41 of the second projection optical system 12b has a space used to accommodate the second image element 11b, and supports the second image element 11b in a state of being aligned with the projection lens 21 and the like illustrated in FIG. 2.

In the first display section 20a, the fastening portion 40f provided at the barrel 41 is provided so as to correspond to the fastening member 50f illustrated in FIG. 3, and enables the upper portion 41x of the barrel 41 to be fixed to the first frame 52a. In the second display section 20b, the fastening portion 40f provided at the barrel 41 is provided so as to correspond to the fastening member 50f illustrated in FIG. 3, and enables the upper portion 41y of the barrel 41 to be fixed to the second frame 52b.

The structure of the barrel 41, that is, the case CA will be described with reference to FIG. 10. The barrel 41, that is, the case CA includes a barrel main body 41a and a barrel cover 41u, and is configured to accommodate the first optical member 2a and hold the second optical member 2b. The barrel main body 41a and the barrel cover 41u are made, for example, of a resin material such as polycarbonate resin to which a black pigment is added to provide light-shielding properties. The barrel main body 41a is a bathtub-shaped container with an open top, and includes an exit port 41o at a portion of a bottom. The barrel cover 41u is fixed so as to cover the barrel main body 41a from above. The barrel main body 41a includes two side plate members 41c (only one of which is illustrated in the drawing), a bottom plate member 41d, a front plate member 41e, and two protruding portions 41f and 41g (see FIG. 9). The two side plate members 41c extend so as to be substantially parallel to the YZ plane that is a vertical plane in which the optical axis AX extends, and be spaced apart from each other. The bottom plate member 41d extends substantially along the horizontal XZ plane, and has a rear end provided with the exit port 41o. The front plate member 41e joins the front end of the bottom plate member 41d and front ends of two side plate members 41c.

Guide protruding portions 45a, 45b, 45c, and 45d having a step are formed at the inside of the side plate member 41c. The guide protruding portions 45a, 45b, 45c, and 45d are protrusions configured to support the first lens 21o, the second lens 21p, and the third lens 21q constituting the first optical member 2a, and the prism mirror 22 of the second optical member 2b. The first lens 21o is bonded in a state of being disposed toward one side and being positioned by the first guide protruding portion 45a, and is supported by the barrel main body 41a. Similarly, the second lens 21p is bonded in a state of being positioned by the second guide protruding portion 45b, and is supported by the barrel main body 41a. In addition, the third lens 21q is bonded in a state of being positioned by the third guide protruding portion 45c, and is supported by the barrel main body 41a. The prism mirror 22 is bonded in a state of being positioned by the fourth guide protruding portion 45d through a protrusion 22t provided at the side surface of the prism mirror 22, and is supported by the barrel main body 41a.

The barrel cover 41u is disposed at an opposite side from the bottom plate member 41d, and covers the inner side of the barrel main body 41a to form an accommodation space IS. The barrel cover 41u includes a top plate 41w and a rear plate 41r. The top plate 41w extends parallel to the XZ plane. The rear plate 41r is disposed and sloped so as to cover the outer side of the reflective surface 22b of the prism mirror 22 of the second optical member 2b. A positioning holder mount 41s having a height reduced by a predetermined height from the surroundings is formed at the front +Z side of the barrel cover 41u, and an insert port 41z is formed at the front of the holder mount 41s. The holder mount 41s provided at the barrel cover 41u is opposed to the base plate 31b of the holder 31 for the first image element 11a. The base plate 31b extends along the holder mount 41s in the horizontal direction, and is fixed to the barrel 41 with adhesive so as to cover a portion of or all of the insert port 41z.

In the barrel 41, the first image element 11a supported by a support frame 31a extending vertically downward from the base plate 31b of the holder 31 is inserted, from above, into a space ISa facing the front plate member 41e through the insert port 41z, and the first image element 11a is fixed in a positioned state.

The virtual-image display device DD according to the first embodiment that has been described above includes: the first display unit 100a including: the first image element 11a; the first projection optical system 12a configured to project the image light ML from the first image element 11a; and the first mirror M1 configured to reflect the image light ML from the first projection optical system 12a; the second display unit 100b including: the second image element 11b; the second projection optical system 12b configured to project the image light ML from the second image element 11b; and the second mirror M2 configured to reflect the image light ML from the second projection optical system 12b; the coupling member 50c configured to couple the first display unit 100a and the second display unit 100b; the penetration-type fitting structure 51 formed at the attaching section 50p and at the support portion 50q, the attaching section 50p being formed at the first display unit 100a, the support portion 50q being provided at the coupling member 50c; and the photocurable-type adhesive material BA held between the attaching section 50p and the support portion 50q, in which a light transmitting structure TR1 is formed, at one of the attaching section 50p and the support portion 50q, between the attaching section 50p and the support portion 50q and at or around the fitting structure 51.

With the virtual-image display device DD, the light transmitting structure TR1 is formed between the attaching section 50p and the support portion 50q and at or around the fitting structure 51. This makes it possible to cause the curing light to reach, through the light transmitting structure TR1, the photocurable-type adhesive material BA held and interposed between the attaching section 50p and the support portion 50q to facilitate sufficient curing. In addition, it is possible to enhance the fastening strength of the attaching section 50p relative to the support portion 50q with the adhesive material BA, that is, enhance the attachment strength of the first display unit 100a relative to the coupling member 50c. Similarly, it is possible to enhance the attachment strength of the second display unit 100b relative to the coupling member 50c.

### Second Embodiment

Below, a virtual-image display device according to a second embodiment will be made. Note that the virtual-image display device according to the second embodiment is provided by partially modifying the virtual-image display device according to the first embodiment. Thus, explanation of portions common to the virtual-image display device according to the first embodiment will not be repeated.

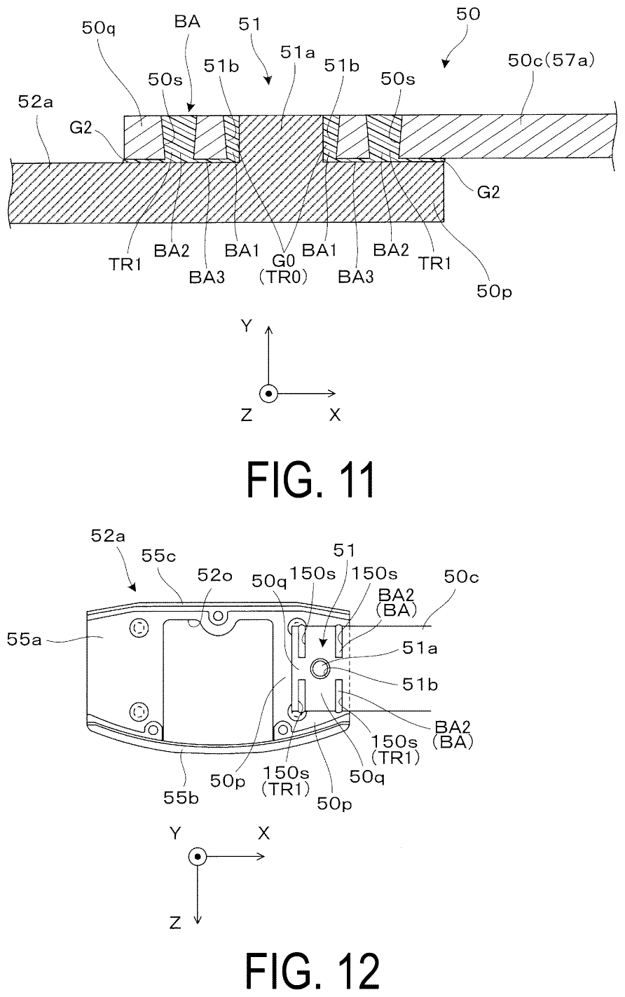

As illustrated in FIG. 11, the through hole 51b of the fitting structure 51 has a tapered shape of which width increases toward the upward from the first frame member 52a or the attaching section 50p. In other words, the through hole 51b has a tapered shape of which cross-sectional size increases toward the upper side, that is, toward the outer side. In addition, the slit-shaped hole 50s adjacent to the fitting structure 51 also has a tapered shape of which width increases toward the upward from the first frame member 52a or the attaching section 50p with respect to the lateral X direction. In other words, the slit-shaped hole 50s has a tapered shape of which cross-sectional size increases toward the upper side, that is, toward the outer side.

The angle of tapering at which the through hole 51b or the slit-shaped hole 50s is sloped relative to the vertical direction is a normal acute angle but is not limited to this.

When the through hole 51b and the slit-shaped hole 50s have a tapered shape in which the upper side is widened as described above, more UV light can reach the boundary region G2 (see FIG. 5). That is, even when the support portion 50q is relatively thick, this configuration enables the UV light to easily enter or reach the bottom of the through hole 51b or the like, which enables the curing to proceed to the deeper side. This makes a half-cured portion or an uncured portion less likely to be formed in the adhesive material BA, which makes it possible to enhance the strength of bonding between the attaching section 50p and the support portion 50q, and makes it possible to enhance the fastening strength of the first frame member 52a and the second frame member 52b relative to the coupling member 50c.

### Third Embodiment

Below, a virtual-image display device according to a third embodiment will be described. Note that the virtual-image display device according to the third embodiment is provided by partially modifying the virtual-image display device according to the first embodiment. Thus, explanation of portions common to the virtual-image display device according to the first embodiment will not be repeated.

As illustrated in FIG. 12, instead of the slit-shaped hole, four notches 150s having a slit shape are formed in the vicinity of the fitting structure 51. In this case, the four notches 150s are elongated and extend in the Z direction that crosses the coupling member 50c. Although the notches 150s are formed so as to penetrate through the support portion 50q, the notch 150s is opened at front and rear ends corresponding to the ±Z direction of the support portion 50q. These notches 150s function as the additional light transmitting structure TR1 configured to allow light to reach the boundary portion between the attaching section 50p and the support portion 50q. The notches 150s also function to guide the light entering the side surface of the support portion 50q to the boundary region G2 (see FIG. 5) between the attaching section 50p and the support portion 50q.

### Modification Examples and Others

These are descriptions of the present disclosure with reference to the embodiments. However, the present disclosure is not limited to the embodiments described above. It is possible to implement the present disclosure in various modes without departing from the spirit of the disclosure. For example, the following modifications are possible.

The optical members 2a and 2b of the first projection optical system 12a or the second projection optical system 12b are not limited to those illustrated in the figures. For example, the number of the optical elements constituting the first optical member 2a and the shape of the optical surface can be appropriately changed in accordance with the purpose of use of the virtual-image display device DD, that is, the HMD 200, or the like.

The embodiments described above use the see-through mirror 23 that partially reflects the image light ML and partially allows the external light OL to pass through. However, instead of the see-through mirror 23, it is possible to use a mirror that reflects most of the image light ML and blocks the external light OL.

The shapes of the protrusion 51a and the through hole 51b that constitute the fitting structure 51 are not limited to a cylindrical shape or tubular shape. It may be possible to take a rib-shape or an elongated hole shape that is elongated in a specific direction.

In the second embodiment, the through hole 51b and the slit-shaped hole 50s have a tapered shape. However, they may have a step extending toward the upper side.

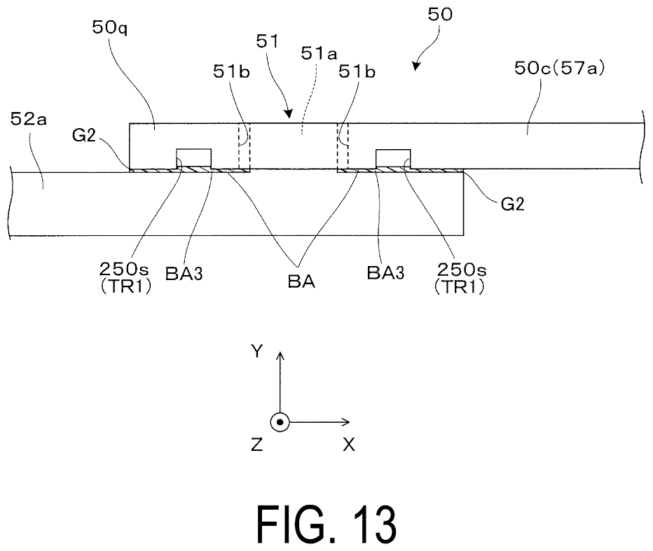

In place of the slit-shaped hole 50s or the notch 150s as illustrated in FIGS. 5, 13, and the like, it may be possible to provide a recess 250s having a shape of a space that causes the attaching section 50p and the support portion 50q to be spaced apart from each other, and does not penetrate through in the longitudinal direction. This recess 250s does not penetrate through the longitudinal direction or the lateral direction. However, this recess 250s may penetrate through a depth direction (Z direction perpendicular to the surface of the paper). The lateral width (width in the lateral X direction on the surface of the paper) of the recess 250s is desirable to be narrow so as to prevent a reduction in the fastening strength. By lengthening the depth size while narrowing the lateral width of the recess 250s, it is possible to cause light to easily reach the boundary region G2.

In the embodiments described above, the first display section 20a or the second display section 20b (specifically, the barrel 41) is fixed to the first frame member 52a or the second frame member 52b. However, it may be possible to employ a configuration in which a light-guiding plate or an optical system associated with the light-guiding plate is fixed to the frame members 52a and 52b. Here, the light-guiding plate is configured to guide image light outputted from the image element to a position opposed to the pupil while reflecting the image light on inner surfaces. In addition, the light-guiding plate is configured to cause the image light to enter the inside from an incident surface provided at the end portion, or is configured to cause the image light to enter the inside through a diffraction element provided at a portion of a parallel flat plate that constitutes the light-guiding plate.

In the description above, the virtual-image display device DD is assumed to be worn and used on the head. However, it may be possible to use the virtual-image display unit 100A, 100B described above as a hand-held display that is not worn on the head and is viewed into it like a pair of binoculars. In other words, in the present disclosure, the head-mounted display also includes a hand-held display.

Either the first display unit 100a or the second display unit 100b may not be provided. In this case, for example, only the first display unit 100a is supported by the support device 50. This makes it possible to configure the coupling member 50c and the frame member 52b as an integrated item. The frame member 52b does not support the optical system, and has a simplified structure joined to the mounting device 100C.

The virtual-image display device according to the specific aspect includes: a first display unit including a first image element, a first projection optical system configured to project image light from the first image element, and a first mirror configured to reflect the image light from the first projection optical system; a coupling member couple to the first display unit; a penetration-type fitting structure formed at an attaching section and at a support portion, the attaching section being formed at the first display unit, the support portion being provided at the coupling member; and a photocurable-type adhesive material held between the attaching section and the support portion, in which a light transmitting structure is formed, at one of the attaching section and the support portion, between the attaching section and the support portion and at or around the fitting structure.

In the virtual-image display device described above, the light transmitting structure is formed at or around the fitting structure and between the attaching section and the support portion. This makes it possible to cause the curing light to reach, through the light transmitting structure, the photocurable-type adhesive material held and interposed between the attaching section and the support portion, and sufficiently promote the curing. In addition, it is possible to enhance the fastening strength of the attaching section relative to the support portion with the adhesive material, that is, enhance the attachment strength of the first display unit relative to the coupling member.

In the virtual-image display device according to the specific aspect, the light transmitting structure is provided at one of the attaching section and the support portion to cause light to reach a boundary region between the attaching section and the support portion. The adhesive material is put in this boundary region.

In the virtual-image display device according to the specific aspect, the light transmitting structure is provided so as to penetrate through one of the attaching section and the support portion to expose the other one. In this case, it is possible to efficiently cure the adhesive material at the exposed portion or surroundings thereof.

In the virtual-image display device according to the specific aspect, the light transmitting structure is provided so as to expose an inner-side region of the boundary region. In this case, it is possible to efficiently cure the adhesive at the internal region or surroundings thereof.

In the virtual-image display device according to the specific aspect, the fitting structure includes a pin-shaped protrusion and a through hole to be fitted with the protrusion. By combining the protrusion and the through hole together, it is possible to easily adjust the position of the first display unit relative to the coupling member.

In the virtual-image display device according to the specific aspect, the protrusion is formed at the attaching section, and the through hole is formed at the support portion. Conversely, the protrusion may be formed at the support portion, and the through hole may be formed at the attaching section.

In the virtual-image display device according to the specific aspect, in the fitting structure, a space is provided between the protrusion and the through hole, the space being configured to adjust relative arrangement of the first display unit and the coupling member. With this configuration, by putting an adhesive in the space between the protrusion and the through hole to cure it in a state in which the position of the first display unit is adjusted with respect to the coupling member, it is possible to fix them while positioning them.

In the virtual-image display device according to the specific aspect, the coupling member is made of metal. When the coupling member is made of metal, the coupling member cannot have optical transparency. However, this makes it possible to increase the accuracy of structure of the coupling member while enhancing the strength of the coupling member and reducing the weight thereof.

In the virtual-image display device according to the specific aspect, the attaching section is made of metal. When the attaching section is made of metal, the attaching section cannot have optical transparency. However, this makes it possible to increase the accuracy of structure of the attaching section while enhancing the strength of the attaching section and reducing the weight thereof.

In the virtual-image display device according to the specific aspect, the adhesive material is put into the space formed in the light transmitting structure. In this case, by causing the curing light to reach the boundary region between the attaching section and the support portion from the light transmitting structure, it is possible to cure the adhesive put into the space of the light transmitting structure and also cure the adhesive that reaches the boundary region between the attaching section and the support portion.

In the virtual-image display device according to the specific aspect, the light transmitting structure includes a slit-shaped hole or notch. The slit-shaped hole or notch is relatively easily machined, which makes it easy to maintain the strength of the attaching section or the support portion.

In the virtual-image display device according to the specific aspect, the light transmitting structure includes a plurality of slit-shaped holes or notches. When a large number of slit-shaped holes or notches are formed, it is easy to cause the curing light to reach the boundary region between the attaching section and the support portion.

In the virtual-image display device according to the specific aspect, the fitting structure is interposed between the plurality of slit-shaped holes or notches. In this case, it is possible to achieve well-balanced fixing at or around the fitting structure.

In the virtual-image display device according to the specific aspect, the slit-shaped hole or notch has a tapered shape of which cross-sectional size increases toward an outer side.

The virtual-image display device according to the specific aspect further includes a second display unit including: a second image element; a second projection optical system configured to project image light from the second image element; and a second mirror configured to reflect the image light from the second projection optical system, and the coupling member is configured to couple the first display unit and the second display unit.

In the virtual-image display device according to the specific aspect, a structure of fixing the second display unit to the coupling member is identical to a structure of fixing the first display unit to the coupling member, and includes a penetration-type fitting structure, a photocurable-type adhesive material, and an additional light transmitting structure. In this case, it is possible to increase the attachment strength of the second display unit relative to the coupling member.

What is claimed is:

1. A virtual image display device comprising:
a first display unit including:
a first image element;
a first projection optical system configured to project image light from the first image element; and
a first mirror configured to reflect the image light from the first projection optical system;
a coupling member coupled to the first display unit;
a penetration-type fitting structure formed at an attaching section and at a support portion, the attaching section being formed at the first display unit, the support portion being provided at the coupling member; and
a photocurable-type adhesive material held between the attaching section and the support portion, wherein
a light transmitting structure is formed, at one of the attaching section and the support portion, between the attaching section and the support portion, and at or around the fitting structure.

2. The virtual image display device according to claim 1, wherein
the light transmitting structure is provided at one of the attaching section and the support portion to cause light to reach a boundary region between the attaching section and the support portion.

3. The virtual image display device according to claim 2, wherein
the light transmitting structure is provided so as to penetrate through one of the attaching section and the support portion to expose the other one.

4. The virtual image display device according to claim 2, wherein
the light transmitting structure is provided so as to expose an inner-side region of the boundary region.

5. The virtual image display device according to claim 1, wherein
the fitting structure includes a pin-shaped protrusion and a through hole to be fitted with the protrusion.

6. The virtual image display device according to claim 5, wherein
the protrusion is formed at the attaching section, and the through hole is formed at the support portion.

7. The virtual image display device according to claim 5, wherein
in the fitting structure, a space is provided between the protrusion and the through hole, the space being configured to adjust relative arrangement of the first display unit and the coupling member.

8. The virtual image display device according to claim 1, wherein the coupling member is made of metal.

9. The virtual image display device according to claim 1, wherein the attaching section is made of metal.

10. The virtual image display device according to claim 1, wherein the adhesive material is put into a space formed in the light transmitting structure.

11. The virtual image display device according to claim 10, wherein the light transmitting structure includes a slit-shaped hole or notch.

12. The virtual image display device according to claim 10, wherein the light transmitting structure includes a plurality of slit-shaped holes or notches.

13. The virtual image display device according to claim 12, wherein the fitting structure is interposed between the plurality of slit-shaped holes or notches.

14. The virtual image display device according to claim 11, wherein the slit-shaped hole or notch has a tapered shape of which cross-sectional size increases toward an outer side.

15. The virtual image display device according to claim 1 further comprising:
a second display unit including:
a second image element;
a second projection optical system configured to project image light from the second image element; and
a second mirror configured to reflect the image light from the second projection optical system, wherein
the coupling member is configured to couple the first display unit and the second display unit.

16. The virtual image display device according to claim 1, wherein
a structure of fixing a second display unit to the coupling member is identical to a structure of fixing the first display unit to the coupling member, and includes a penetration-type fitting structure, a photocurable-type adhesive material, and an additional light transmitting structure.
